(19) United States
(12) Patent Application Publication
(10) Pub. No.: US 2006/0192330 A1
(43) Pub. Date: Aug. 31, 2006

(54) Sheet feeding device and image forming apparatus

(75) Inventors: Akira Nakashima, Soraku-gun (JP); Toyoaki Nanba, Higashiosaka-shi (JP); Yasuhiro Takai, Sakurai-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/362,335

(22) Filed: Feb. 27, 2006

(30) Foreign Application Priority Data
Feb. 28, 2005 (JP) 2005-53845

(51) Int. Cl. B65H 3/06; B41F 13/24

(52) U.S. Cl. 271/119; 101/232

(57) ABSTRACT

A sheet feeding device includes a sheet stacker and a locking mechanism. The sheet stacker has a stacking plate adapted for sheets to be stacked thereon. The sheet stacker is movable between a first position and a second position. In the first position, the sheet stacker is entirely housed in a casing, and, in the second position, is entirely exposed outside of the casing. The locking mechanism is adapted to lock the sheet stacker to the casing at each of the first and second positions. This arrangement prevents the sheet stacker as pulled out of the casing for sheet replenishment from being moved.

### CROSS REFERENCE

This Nonprovisional application claims priority under 35 U.S.C. § 119(a) on Patent Application No. 2005-053845 filed in Japan on Feb. 28, 2005, the entire contents of which are hereby incorporated by reference.

### BACKGROUND OF THE INVENTION

The present invention relates to sheet feeding devices, such as large capacity cassettes (hereinafter merely referred to as LCCs), adapted for use in sheet processing apparatus, such as image forming apparatus, to store therein a large number of sheets to be fed into the apparatus. The present invention further relates to image forming apparatus provided with such sheet feeding devices.

Conventional sheet feeding devices have a sheet stacker with a stacking plate adapted for sheets to be placed thereon. For replenishment of sheets, a user opens a front door of such device to pull the sheet stacker out of the device. Such sheet stacker has a capacity of up to approximately 4000 sheets of A3-size paper which weigh approximately 40 kg.

JP 2002-145463A discloses a sheet feeding device provided with a locking mechanism that is adapted to prevent a sheet stacker from being moved during duration of sheet feeding operation. The locking mechanism is designed to prevent misalignment of stacked sheets for proper sheet feeding.

In the prior art feeding device, however, the sheet stacker as pulled out is not prevented from being moved during duration of sheet replenishment. Movement of the sheet stacker during the duration may cause injury or sheet misalignment.

In view of the foregoing, a feature of the invention is to offer a sheet feeding device provided with a locking mechanism of simplified configuration that is adapted to prevent movement of a sheet stacker as entirely pulled out of, or housed in, a casing, and an image forming apparatus provided with such sheet feeding device. The locking mechanism ensures ease of, and safety in, sheet replenishment operation. The locking mechanism also prevents sheet misalignment, thereby improving sheet feeding performance.

### SUMMARY OF THE INVENTION

A sheet feeding device according to the invention includes a sheet stacker and a locking mechanism. The sheet stacker has a stacking plate adapted for sheets to be stacked thereon. The sheet stacker is movable between a first position and a second position. In the first position, the sheet stacker is entirely housed in a casing, and, in the second position, is entirely exposed outside of the casing. The locking mechanism is adapted to lock the sheet stacker to the casing at each of the first and second positions. Thus, the sheet stacker is prevented from being moved when pulled out of the casing for sheet replenishment.

### BRIEF DESCRIPTION OF THE DRAWINGS

FIG. 1 is a schematic cross-sectional view of an image forming apparatus as a sheet processing apparatus to which a sheet is fed from an LCC according to embodiments of the invention;

FIG. 2 is a schematic cross-sectional view of an LCC according to a first embodiment of the invention;

FIGS. 3A and 3B are schematic top cross-sectional views of the LCC;

FIG. 4A is a schematic side cross-sectional view of the LCC, and FIG. 4B is a schematic top view illustrating an inner bottom surface of a casing;

FIG. 5 is a schematic side view of a wheel;

FIGS. 6A to 6C are a top view, a side cross-sectional view, and a cross-sectional view along a line A-A′, respectively, of a first recess, a second recess, and a rib;

FIGS. 7A and 7B are diagrams illustrating a manner in which the wheel is engaged with, and disengaged from, the first recess;

FIG. 8A is a schematic side cross-sectional view of an LCC according to a second embodiment of the invention, and FIG. 8B is a schematic top view illustrating an inner bottom surface of a casing; and

FIGS. 9A and 9B are schematic side views of a wheel.

### DETAILED DESCRIPTION OF THE INVENTION

### First Embodiment

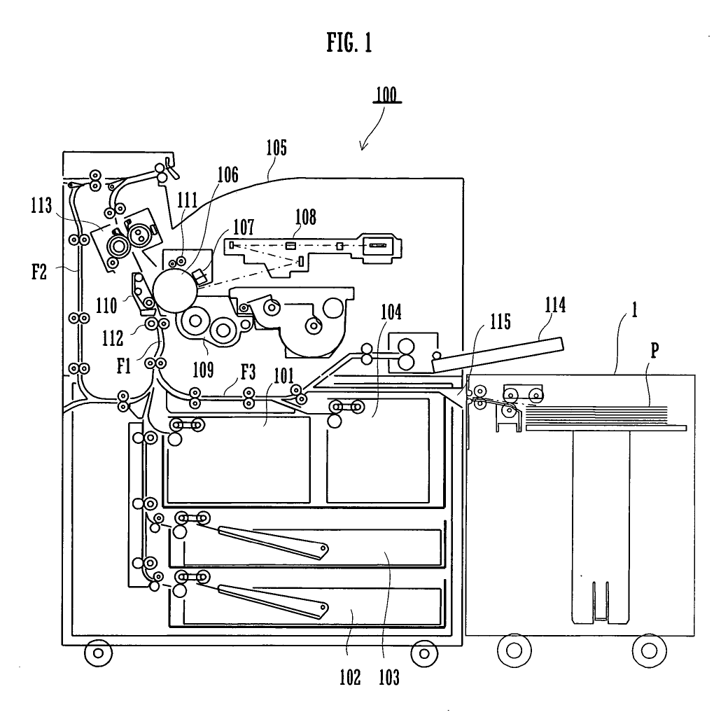

Referring to the accompanying drawings, preferred embodiments of the invention are described below. Referring to FIG. 1, an LCC 1 as the sheet feeding device of the invention is arranged beside an image forming apparatus 100. Instead of the single LCC 1 as in a first embodiment, a plurality of LCCs may be arranged in alignment with one another. The LCC 1 feeds a sheet P of paper, or another material such as OHP film, into the image forming apparatus 100.

The image forming apparatus 100 forms an image on the sheet P by performing an electrophotographic image forming process. The image forming apparatus 100 has sheet cassettes 101 to 104 and a sheet output tray 105 in a bottom portion and a top portion thereof, respectively. A sheet transport path F1 is provided so as to lead from the sheet cassettes 101 to 103 to the sheet output tray 105. A photoreceptor drum 106 is positioned close to the sheet transport path F1. Around the photoreceptor drum 106 arranged are a charging device 107, an optical scanning unit 108, a developing unit 109, a transferring device 110, a cleaning unit 111, and the like.

Registration rollers 112 are provided upstream of the photoreceptor drum 106 in the sheet transport path F1. The registration rollers 112 feed the sheet P to a transfer area located between the photoreceptor drum 106 and the transferring device 110 in synchronization with rotation of the photoreceptor drum 106. A fusing device 113 is provided downstream of the photoreceptor drum 106 in the sheet transport path F1.

The charging device 107 applies a predetermined level of electrostatic charge to a circumferential surface of the photoreceptor drum 106. The optical scanning unit 108 forms an electrostatic latent image on the circumferential surface of the photoreceptor drum 106 based on external input image data. The developing unit 109 supplies toner to the circumferential surface and develops the electrostatic latent image into a toner image. The transferring device 110 transfers the toner image as formed on the circumferential surface to the sheet P. The fusing device 113 fixes the toner image onto the sheet P. The sheet P with the toner image fixed thereto is output to the sheet output tray 105. The cleaning unit 111 removes and collects residual toner that remains on the circumferential surface after the transfer operation is completed.

The image forming apparatus 100 is also provided with a switchback transport path F2 and a sheet transport path F3. In a duplex image forming process in which an image is formed on each side of sheet P, the sheet P with an image formed on a first side is transported to the transfer area on the switchback transport path F2, with the first and a second sides reversed. Sheets fed from each of the sheet cassette 104, a manual feeding tray 114, and a sheet receiving section 115 is transported on the sheet transport path F3.

The tray 114 is provided on a side surface of the image forming apparatus 100 for feeding sheets of various sizes. The section 115 is provided for receiving sheets fed from the LCC 1. The path F3 extends approximately horizontally so as to join, at one end, the path F1 at an upstream point of the registration rollers 112 and be divided, at the other end, to lead to each of the sheet cassette 104, the tray 114, and the section 115.

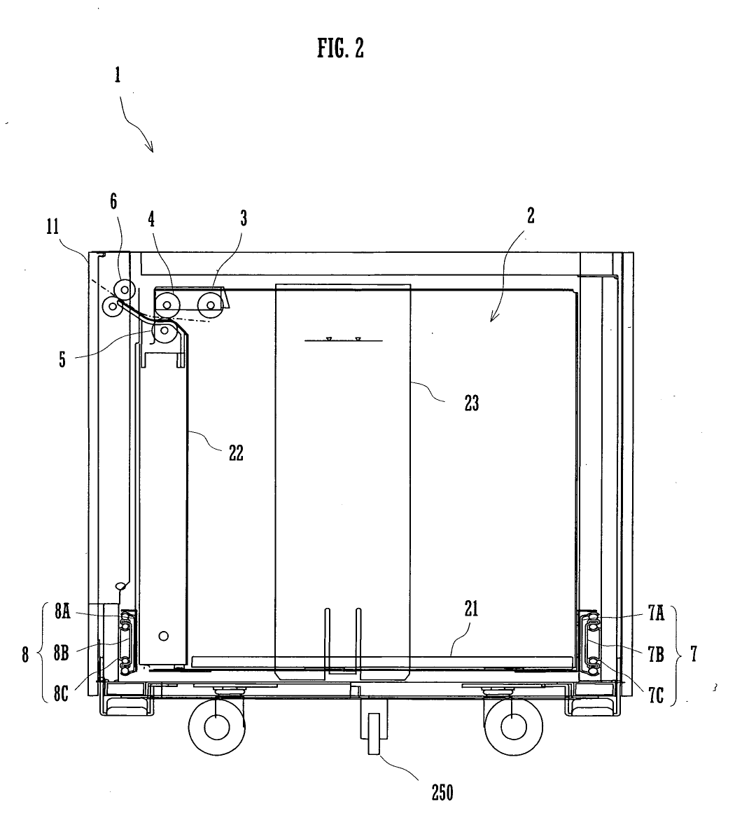

Referring to FIG. 2, the LCC 1 includes a casing 11, a sheet stacker 2, a pick-up roller 3, a feeding roller 4, a reversing roller 5, and transporting rollers 6.

The sheet stacker 2 has a stacking plate 21, a front guiding plate 22, side guiding plates 23 and 24, and a rear guiding plate. The side guiding plate 24 and the rear guiding plate are not shown in the figure. Held in a horizontal position, the stacking plate 21 is provided for a plurality of sheets to be stacked thereon. The sheets as stacked are positioned with the front guiding plate 22, the side guiding plates 23 and 24, and the rear guiding plate.

The pick-up roller 3 is supported so as to be pivotable about a rotary shaft for the feeding roller 4 reciprocally between an upper position and a lower position. The pick-up roller 3 picks up a top one of sheets stacked on the stacking plate 21 in order to lead the top sheet between the feeding roller 4 and the reversing roller 5.

The rollers 4 and 5 are both rotated clockwise in FIG. 2 to allow passage of the sheet therebetween. In a case where multiple sheets are picked up at a time and led between the rollers 4 and 5 by the roller 3, only a top one of the sheets are brought into contact with the roller 4 and led to the transporting rollers 6. The rest of the sheets are returned to the stacking plate 21 by the reversing roller 5.

The LCC 1 has a capacity of a large number of sheets (approximately 4,000 sheets in the present embodiment) of various sizes such as of A3, B4, A4, and B5.

The side guiding plates 23 and 24 are rendered movable on the stacking plate 21 within a predetermined range from frontward to rearward, and vice versa, of the LCC 1. More specifically, the plates 23 and 24 are rendered movable in two opposite directions perpendicular to a sheet feeding direction. Movement of one of the plates 23 and 24 in one of the two directions is transmitted to the other, so that the other is moved in the opposite direction. Accordingly, sheets stacked on the stacking plate 21 are positioned approximately at the center of the stacking plate 21 along the two opposite directions. In addition, the rear guiding plate is rendered movable within a predetermined range from side to side of the LCC 1, i.e., movable along the sheet feeding direction.

The sheet stacker 2 has a lifting motor in the rear side surface. Rotation of the lifting motor is transmitted through wire, so that the stacking plate 21 is lifted up and down along a not-shown guiding shaft while being held in a horizontal position.

Inside the LCC 1, there are provided slide rail assemblies 7 and 8. The slide rail assembly 7 includes a sliding member 7A, an intermediate member 7B, and a fixed member 7C. The slide rail assembly 8 includes a sliding member 8A, an intermediate member 8B, and a fixed member 8C. The sliding members 7A and 8A are attached to the right and left outer side surfaces of the sheet stacker 2, respectively. The fixed members 7C and 8C are fixed to the right and left inner side surfaces of the casing 11, respectively.

There are ball bearings arranged between the sliding member 7A and the intermediate member 7B and between the intermediate member 7B and the fixed member 7C, respectively. The sliding member 7A is slidable reciprocally from frontward to rearward, and vice versa, of the LCC 1 with respect to the intermediate member 7B. Further, the intermediate member 7B is slidable reciprocally from frontward to rearward, and vice versa, of the LCC 1 with respect to the fixed member 7C. The slide rail assembly 8 has a similar construction to that of the assembly 7.

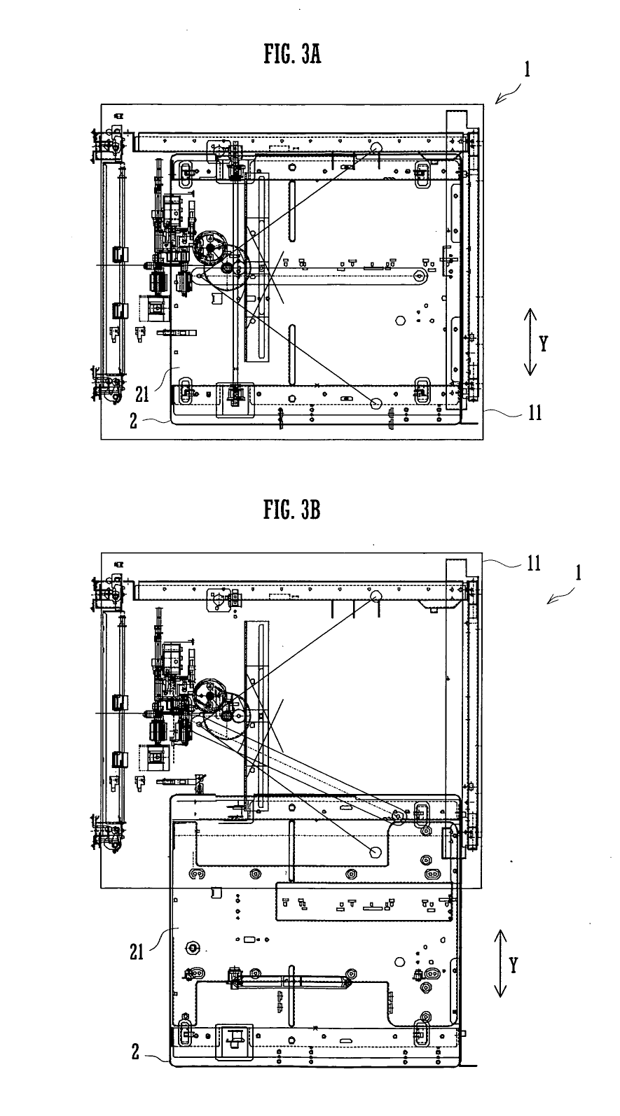

The slide rail assemblies 7 and 8 allow the sheet stacker 2 to be detachably housed in the casing 11. Specifically, the sheet stacker 2 is movable horizontally, in two opposite directions of double-headed arrow Y, between a housed position as shown in FIG. 3A and an exposed position as shown in FIG. 3B. In the housed position, the sheet stacker 2 is housed in the casing 11. The sheet stacker 2 is pulled out from the housed position to the exposed position where the entire stacking plate 21 is exposed at the front of the LCC 1. The housed position and the exposed position correspond to the first and second positions of the invention, respectively.

When the sheet stacker 2 is pulled out from the housed position to the exposed position, the sliding member 7A together with the intermediate member 7B is first slid frontward with respect to the fixed member 7C. Then, when the sheet stacker 2 is still pulled after the intermediate member 7B is slid a maximum sliding distance with respect to the fixed member 7C, the sliding member 7A is slid further frontward with respect to the intermediate member 7B. Thus, a maximum pullout distance of the sheet stacker 2 is a sum of the maximum sliding distance of the intermediate member 7B with respect to the fixed member 7C and a maximum sliding distance of the sliding member 7A with respect to the intermediate member 7B.

When the sheet stacker 2 is pushed into the casing 11 from the exposed position to the housed position, the intermediate member 7B is first slid with respect to the fixed member 7C, with the sliding member 7A projecting frontward. Then, when the sheet stacker 2 is still pushed after the intermediate member 7B is slid a maximum sliding distance with respect to the fixed member 7C, the sliding member 7A is slid further into the casing 11 with respect to the intermediate member 7B. The slide rail assembly 8 is slid in a similar manner when the sheet stacker 2 is pulled out of, or pushed into, the casing 11.

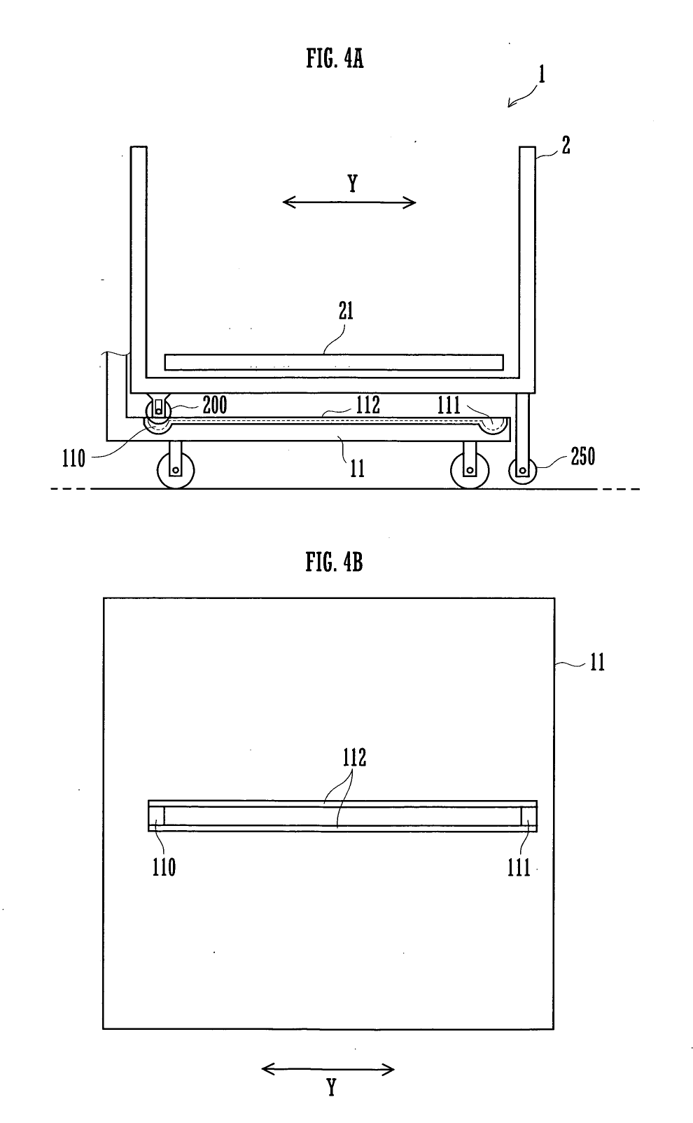

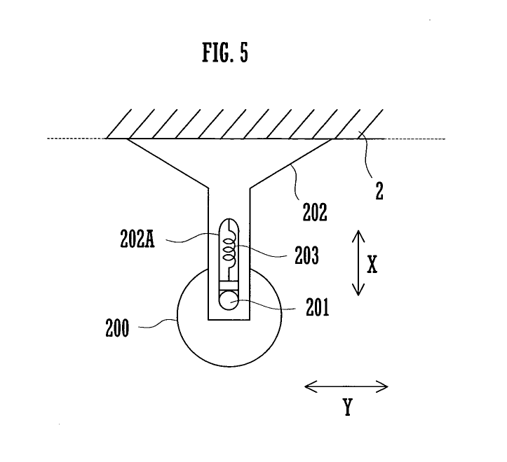

FIG. 4A is a side cross-sectional view of the LCC 1. FIG. 4B is a top view illustrating an inner bottom surface of the casing 11. Referring to FIG. 4, the sheet stacker 2 has a wheel 200 and an auxiliary wheel 250 both mounted on an outer bottom surface thereof. Referring to FIG. 5, the wheel 200 is supported rotatably about a rotary shaft 201 that is oriented perpendicular to the directions of double-headed arrow Y. As the sheet stacker 2 is moved in the directions of double-headed arrow Y, the wheel 200 is moved while being rotated. The rotary shaft 201 is supported at both ends by supports 202, respectively.

Each of the supports 202 has a slit 202A formed therein for guiding the rotary shaft in two vertical directions of two-headed arrow X. A spring 203 is arranged in each of the slits 202A in order to apply such an elastic force as to move the rotary shaft 201 in the directions of two-headed arrow X.

Referring back to FIG. 4A, the wheel 200 is in contact with the inner bottom surface of the casing 11. The wheel 200 is guided in a rib 212 between a first recess 210 and a second recess 211 both formed in the inner bottom surface.

The wheel 200 is engaged with the first recess 210 when the sheet stacker 2 is in the housed position. The wheel 200 is engaged with the second recess 211 when the stacker 2 is in the exposed position. Referring to FIG. 4, the rib 212 is positioned between the first recess 210 and the second recess 211 in the inner bottom surface. The rib 212 is arranged so as to have contact with each end of the wheel 200.

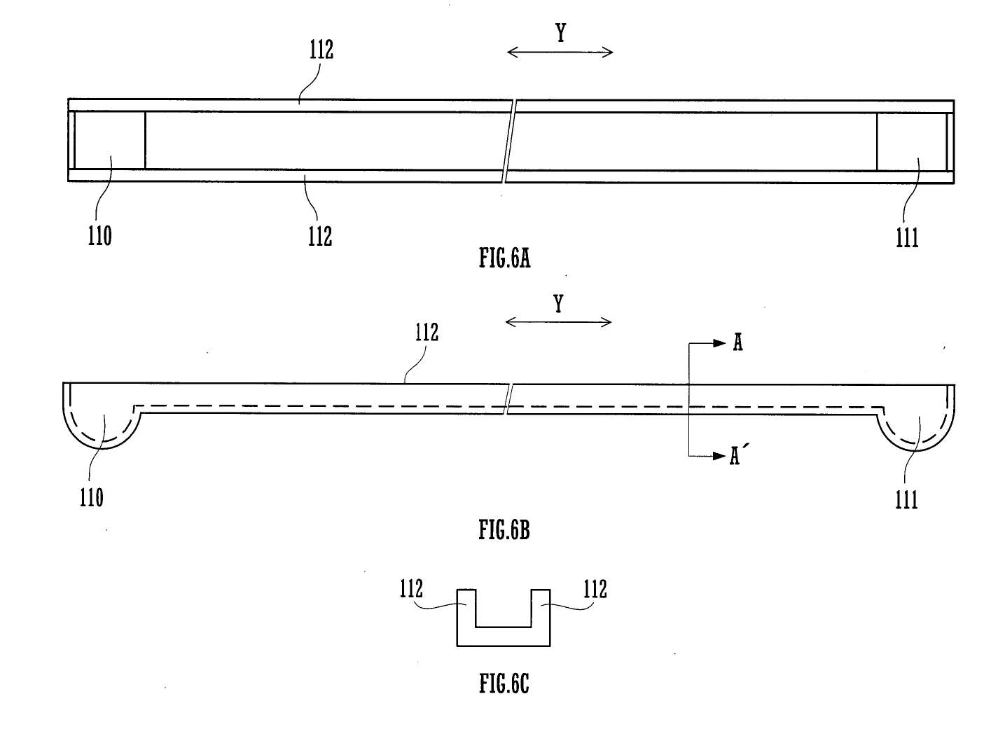

Further, referring to FIGS. 6A and 6B, the first recess 210, the second recess 211, and the rib 212 are formed integrally with one another. FIGS. 6A to 6C are a top view, a side cross-sectional view, and a cross-sectional view along a line A-A′, respectively, of the first recess 210, the second recess 211, and the rib 212.

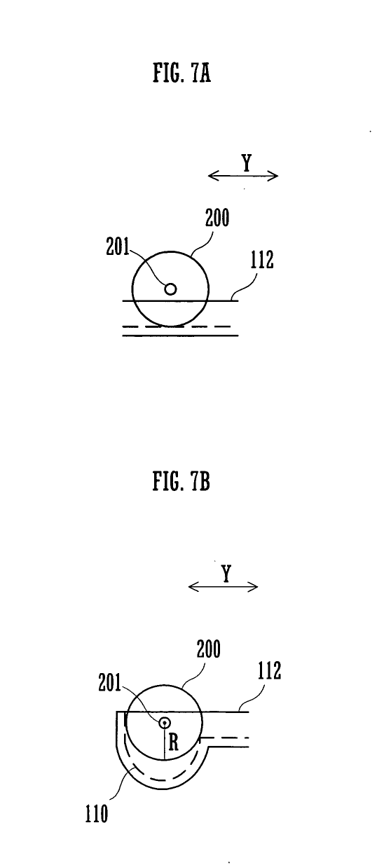

In a state as shown in FIG. 7A, the wheel 200 is movable between the first recess 210 and the second recess 211. When the wheel 200 is moved to a position to face the first recess 210 or the second recess 211, the wheel 200 is urged downward by the springs 203 and engaged with the first recess 210 or the second recess 211, as shown in FIG. 7B.

When a user pushes or pulls the sheet stacker 2 in either of the two directions of double-headed arrow Y, the wheel 200 is disengaged from the first recess 210 or the second recess 211 and guided in the rib 212.

With the sheet stacker 2 housed in the casing 11, referring back to FIG. 4A, the auxiliary wheel 250 faces a floor surface across a small space. As the sheet stacker 2 is pulled out of the casing 11, the auxiliary wheel 250 is brought into contact with the floor surface, thereby providing auxiliary support to the sheet stacker 2. This is because the slide rail assemblies 7 and 8 cannot provide sufficient support to the sheet stacker 2, in particular with a maximum number of sheets stacked therein.

Accordingly, the sheet stacker 2 in the housed position is supported with the bottom surface maintained in a horizontal position. In the exposed position, the sheet stacker 2 has the bottom surface declined frontward.

The simple arrangement as described above allows the sheet stacker 2 to be locked to the casing at each of the housed and exposed positions, thereby ensuring ease of, and safety in, replenishing sheets in the sheet stacker 2. Also, the arrangement prevents stacked sheets from coming out of alignment, thereby allowing improved sheet feeding performance.

The rotatable wheel 200 as the projecting member of the invention contributes to a reduction in friction by contact with the inner surface of the casing 11, i.e., a reduction in resistance to movement of the sheet stacker 2. Also, a force that a user applies to move the sheet stacker 2 in the directions of double-headed arrow Y is used to disengage the sheet stacker 2 from the first recess 210 or the second recess 211.

Further, referring to FIG. 7B, the wheel 200 has a smaller depth of engagement with the first recess 210 or the second recess 211 than radius R thereof. Compared with full engagement, the partial engagement allows a user to apply a smaller force to the sheet stacker 2 for disengagement, thereby further facilitating disengagement of the wheel 200 from either of the first recess 210 and the second recess 211.

The wheel 200 with a vertical, circular cross-section along the directions of double headed arrow Y corresponds to the projecting member of the invention with a vertical cross-section of circular arc that projects toward the casing 11. The locking mechanism according to the first embodiment includes the wheel 200, the first recess 210, and the second recess 211.

### Second Embodiment

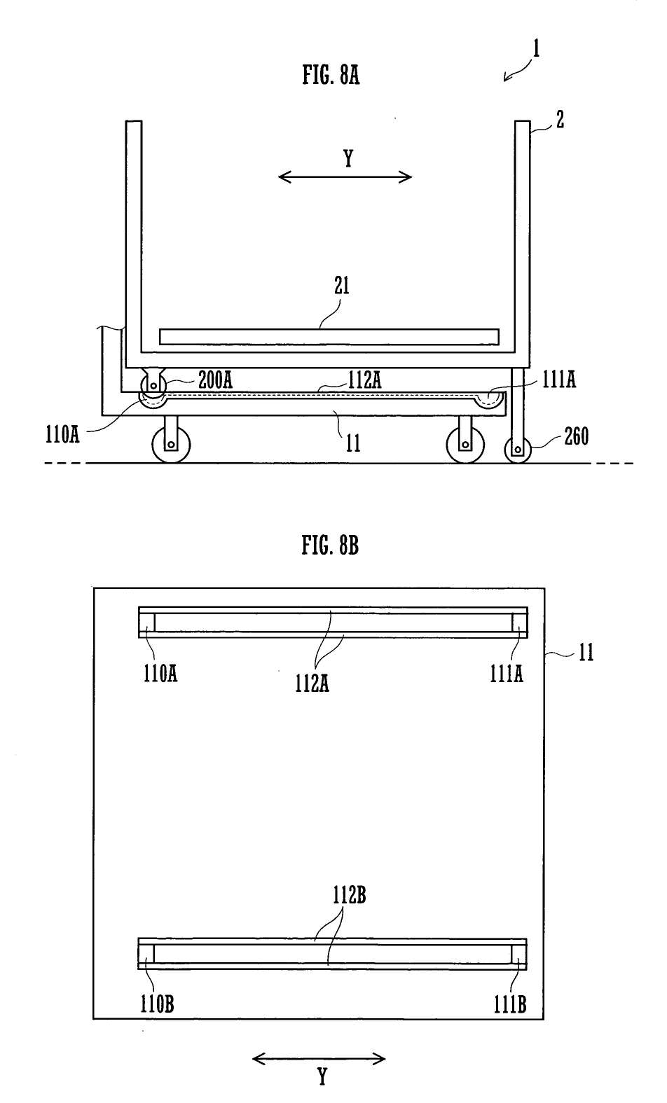

Described below is a second embodiment of the invention that is silmilar in construction to the first embodiment. Instead of the slide rail assemblies as used in the first embodiment, however, two wheels 200A and 200B and an auxiliary wheel 260 are used to support the sheet stacker 2, as shown in FIGS. 8A and 8B. The wheel 200B is not shown in the figures. FIG. 8A is a side cross-sectional view of the LCC 1. FIG. 8B is a top view illustrating an inner bottom surface of the casing 11.

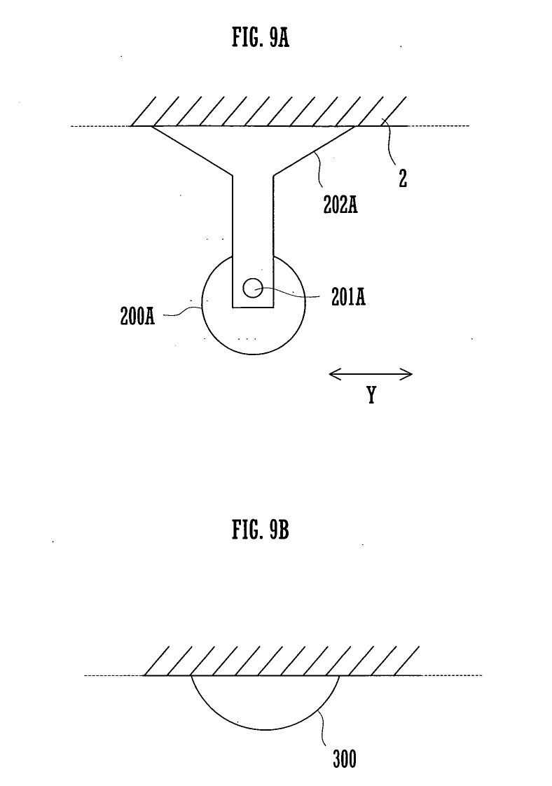

Referring to FIG. 9A, the wheels 200A and 200B are supported rotatably about rotary shafts 201A and 201B, respectively, although the wheel 200B and the shaft 201B are not shown in the figure. The rotary shafts 201A and 201B are oriented perpendicular to the directions of double-headed arrow Y. The rotary shafts 201A and 201B are supported by supports 203A and 203B, respectively. The support 203B is not shown in the figure. The wheels 200A and 200B are engaged with first recesses 210A and 210B, respectively, when the sheet stacker 2 is in the housed position. The wheels 200A and 200B are engaged with second recesses 211A and 211B, respectively, when the stacker 2 is in the exposed position.

When the sheet stacker 2 is moved between the housed position and the exposed position, the wheels 200A and 200B are guided in ribs 212A and 212B, respectively, in the directions of double-headed arrow Y while being rotated. Thus, the sheet stacker 2 is guided in the directions of double-headed arrow Y by the ribs 212A and 212B and the wheels 200A and 200B.

The sheet stacker 2 is supported with the bottom surface maintained in a horizontal position, when the wheels 200A and 200B are in engagement with the respective first recesses 210A and 210B or with the respective second recesses 211A and 211B. Accordingly, the sheet stacker 2 has the bottom surface declined frontward when the wheels 200A and 200B are out of engagement with the respective first recesses 210A and 210B or with the respective second recesses 211A and 211B.

Unlike the auxiliary wheel 250 in the first embodiment, the auxiliary wheel 260 is in constant contact with the floor surface, thereby providing constant support to the sheet stacker 2, even when in the housed position.

The arrangement as described above has the similar advantages to those of the first embodiment. The locking mechanism according to the second embodiment includes the wheels 200A and 200B, the first recesses 210A and 210B, and the second recesses 211A and 211B.

The projecting member of the invention includes, but is not limited to, the wheel 200 in the first embodiment and the wheels 200A and 200B in the second embodiment. Any member will suffice as the projecting member, as long as the member has a vertical cross-section, along the directions of double-headed arrow Y, of circular arc that projects toward the casing 11. For example, a spherical member 300 as shown in FIG. 9B suffices as the projecting member.

Alternatively, the wheels 200, 200A, and 200B can be mounted on a side surface of the sheet stacker 2, instead of on the bottom surface of the sheet stacker 2 as in the first and second embodiments.

The LCC 1 according to the first or second embodiment is adaptable for use not only with the image forming apparatus 100 but also with a sheet processing apparatus for performing a certain process to a sheet fed from the LCC 1.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A sheet feeding device comprising:
a sheet stacker having a stacking plate adapted for sheets to be stacked thereon, the sheet stacker being adapted to be movable between a first position where the sheet stacker is entirely stored in a casing and a second position where the sheet stacker is entirely exposed out of the casing; and
a locking mechanism adapted to lock the sheet stacker to the casing at each of the first and second positions.

2. The sheet feeding device according to claim 1,
wherein the locking mechanism includes:
a projecting member adapted to be mounted on an outer surface of the sheet stacker in such a manner as to have contact with an inner surface of the casing, the projecting member having a vertical cross-section, along a moving direction of the sheet stacker, of circular arc;
a first recess provided in the inner surface and adapted to be engaged with the projecting member when the sheet stacker is in the first position; and
a second recess provided in the inner surface and adapted to be engaged with the projecting member when the sheet stacker is in the second position.

3. The sheet feeding device according to claim 2,
wherein the projecting member is a wheel that is supported rotatably about a rotary shaft oriented perpendicular to the moving direction.

4. The sheet feeding device according to claim 2,
wherein the projecting member has a smaller depth of engagement with each of the first and second recesses than radius of the circular arc.

5. The sheet feeding device according to claim 2, further comprising a rib, the rib being provided between the first and second recesses in such a manner as to have contact with both sides of the projecting member while the projecting member is being moved in the moving direction.

6. An image forming apparatus provided with an image forming unit adapted to form an image on a sheet, the image forming apparatus comprising the sheet feeding device of claim 1, the sheet feeding device being adapted to feed a sheet to the image forming unit.

7. The image forming apparatus according to claim 6,
wherein the locking mechanism includes:
a projecting member adapted to be mounted on an outer surface of the sheet stacker in such a manner as to have contact with an inner surface of the casing, the projecting member having a vertical cross-section, along a moving direction of the sheet stacker, of circular arc;
a first recess provided in the inner surface and adapted to be engaged with the projecting member when the sheet stacker is in the first position; and
a second recess provided in the inner surface and adapted to be engaged with the projecting member when the sheet stacker is in the second position.

8. The image forming apparatus according to claim 7,
wherein the projecting member is a wheel that is supported rotatably about a rotary shaft oriented perpendicular to the moving direction.

9. The image forming apparatus according to claim 7,
wherein the projecting member has a smaller depth of engagement with each of the first and second recesses than radius of the circular arc.

10. The image forming apparatus according to claim 7, further comprising a rib, the rib being provided between the first and second recesses in such a manner as to have contact with both sides of the projecting member while the projecting member is being moved in the moving direction.
